(19) United States
(12) Patent Application Publication
(10) Pub. No.: US 2009/0077767 A1
(43) Pub. Date: Mar. 26, 2009

(54) HINGE

(75) Inventor: Michael Brian Alchin, Mittagong (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Azuma Design PTY Limited, Wetherill Park (AU)

(21) Appl. No.: 11/904,379

(22) Filed: Sep. 26, 2007

(51) Int. Cl. E05D 7/04

(52) U.S. Cl. 16/237

(57) ABSTRACT

A hinge (10) including a first hinge half (11) to be fixed to a door jamb, and a second hinge half (12) to be fixed to the door. The hinge half (11) has a base (15) with projections (30). The second hinge half (12) has a pivot pin engaging member (16) with slots (33) within which the projections (30) are located to connect the hinge halves (11 and 12).

### TECHNICAL FIELD

The present invention relates to hinges for doors and windows and more particularly to adjustable hinges.

### BACKGROUND OF THE INVENTION

Typically hinges consist of two plates, each plate having an eyelet or eyelets, with the eyelets aligned and receiving a pivot pin.

If the door jamb and door are correctly constructed and correctly installed, then the abovementioned hinges are generally suitable. However installation of the hinge and/or inaccuracy in the dimensions of the door and/or door jamb can result in difficulty in mounting the door with respect to the doorjamb.

The abovementioned difficulty results in lost time and in some instances damaged the door and/or door jamb.

### OBJECT OF THE INVENTION

It is the object of the present invention to overcome or substantially ameliorate at least one of the above discussed disadvantages.

### SUMMARY OF THE INVENTION

There is disclosed herein a hinge including:

a first hinge half,

a second hinge half;

a pin pivotally coupling the hinge halves for pivoting movement about a pivot axis; and wherein

said first hinge half includes,

a base to be fixed to a door or door jamb,

a pin engaging member attached to the base and engaging the pin to pivotally attach the binge halves, said pin engaging member being adjustable in a direction for movement generally parallel to said axis relative to said base, with the base and member being coupled by a slot extending generally parallel to said axis and a projection slidably located in said slot for sliding movement therealong and located in said slot so as to prevent separation of the projection and the slot in a transverse direction transverse relative to said axis.

Preferably, said slot is a first slot and said projection is a first projection, with said base and member being coupled by a second slot, said second slot extending generally parallel to said axis, and a second projection, the second projection being slidably located in said second slot for movement therealong, said second projection being operatively associated with the second slot to prevent separation of the second slot and second projection in a transverse direction with respect to said axis.

Preferably, said projection includes at least one flange that prevents said transverse separation.

Preferably, said each projection is attached to said base, and said member includes the slot/s.

Preferably, each slot includes a neck defined between a pair of neck flanges, and each projection projects through a respective one of the necks, with each neck flange engaging the associated projection to prevent said transverse separation.

Preferably, said member includes at least one elongated slot through which a threaded fastener passes to secure the member to the base in a desired location with respect thereto.

Preferably, said base and member have serrations that engage to aid in retaining the member fixed to said base in a desired location.

Preferably, said hinge second half includes a second half base and a second half pin engaging member adjustably attached to the second half base, with said pin pivotally coupling the member of said first hinge half and the member of said hinge second half.

Preferably, said hinge second half base has at least one slot extending generally transverse of said axis, and said hinge second-half member has a projection located in said slot to provide for adjustment of said second hinge half member with respect to said second hinge halfbase in a direction transverse of said axis.

Preferably, said second binge half member has at least one slot extending generally transverse of said axis to receive a fastener and provide for relative adjustment of said second hinge half member relative to said second hinge half base.

### BRIEF DESCRIPTION OF THE DRAWINGS

A preferred form of the present invention will now be described by way of example with reference to the accompanying drawings wherein:

FIG. 1 is a schematic isometric view of a hinge to pivotally attach a door to a door jamb;

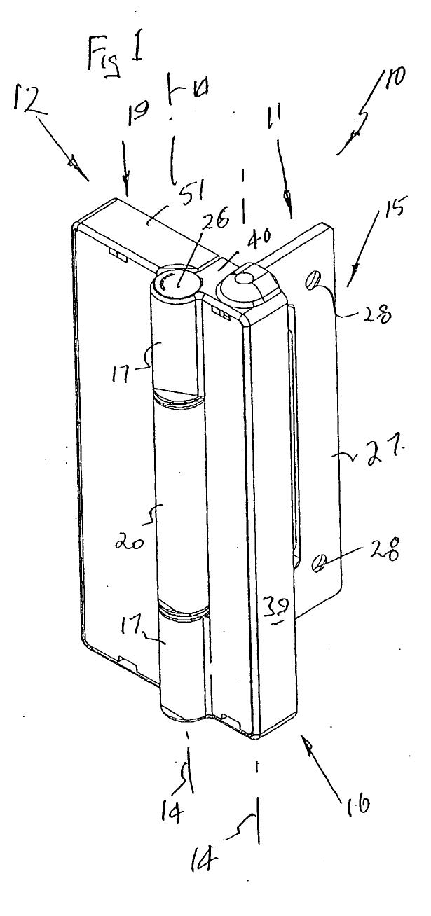

FIG. 2 is a schematic isometric view of the hinge of FIG. 1;

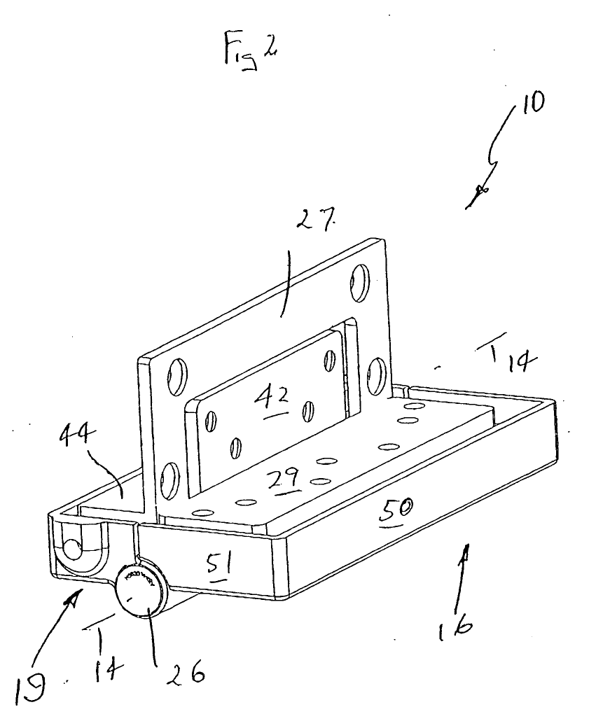

FIG. 3 is a schematic parts exploded isometric view of the hinge of FIG. 1; and

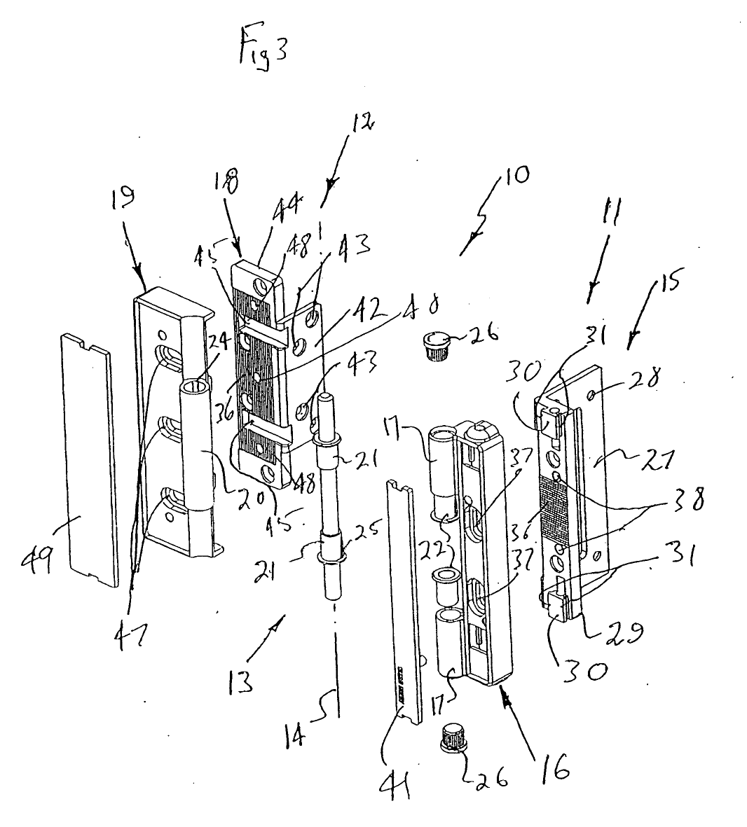

FIG. 4 is a further schematic parts exploded isometric view of the hinge of FIG. 1.

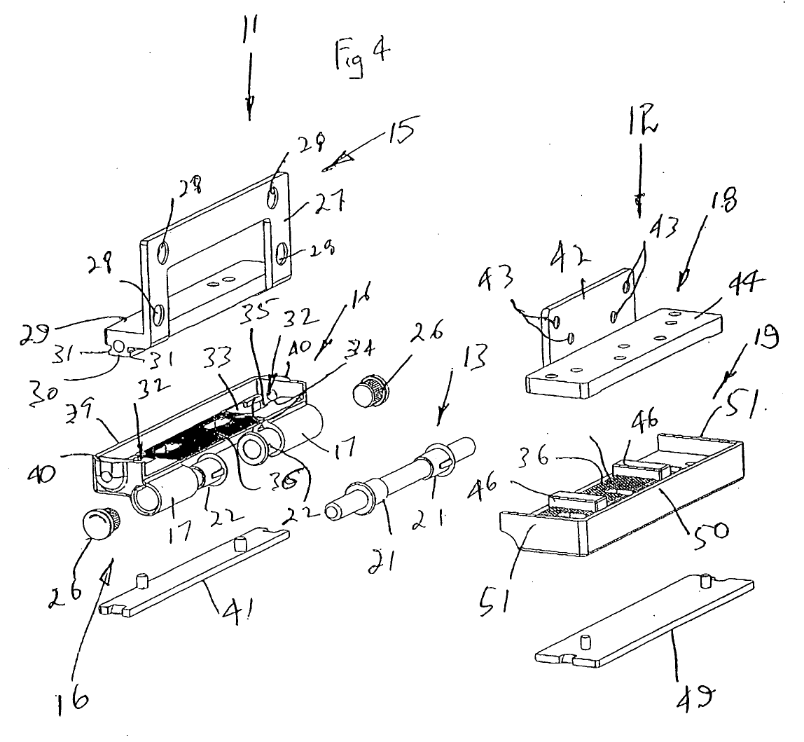

### DETAILED DESCRIPTION OF THE PREFERRED EMBODIMENT

In the accompanying drawings there is schematically depicted a hinge 10. The hinge 10 includes a first hinge half 11 to be fixed to a door jamb, and a second hinge half 12 to be fixed to a door, with the hinge halves 11 and 12 being pivotally coupled by means of a pin 13, the pin 13 providing a pivot axis 14 about which the door pivots relative to the associated door jamb.

The hinge half 11 includes a base 15 and a pin engaging member 16 having eyelets 17. The second hinge half 12 also has a base 18 and a pin engaging member 19. The pin engaging member 19 having an eyelet 20 that is aligned with the eyelets 17 to receive the pin 13.

Engaged within the eyelet 20 are bushes 21 of plastics material that provide a bearing in respect of the pin 13. The eyelets 17 have plastic bushes 22 that also engage the pin 13 and provide a bearing in respect thereof. Accordingly the pin 13 is securely retained in the eyelets 17 and 20 by means of the bushes 21 and 22, with the bushes 21 and 22 co-operating to support the door for pivoting movement. Preferably the eyelets 17 and 20 have recesses 24, with each of the recesses 24 engaging a projection 25 on associated one of the bushes 21 or 23, Received within the upper and lower extremities of the eyelets 17 are caps 26.

The base 15 includes a mounting plate 27 having apertures 28 through which fasteners pass to secure the plate 27 to the door jamb. Extending generally normal to the plate 27 is a base flange 29, the flange 29 having projections 30. The projections 30 extend generally normal relative the axis 14 and flange 29, and are of a “T” transverse cross section so as to have parallel flanges 31. The member 16 has a pair of slots 32 each having an enlarged entrance portion 33 through which the projections 30 may pass. Each slot 32 is at least partly defined between a pair of flanges 34 that project toward each other and parallel to the axis 14 so as to provide a neck 35 through which the associated one of the projection 30 extend. The neck extends parallel to the axis 14. In particular the flanges 31 are located behind the flanges 34 so that once the projections 30 are located in their respective slots 32, and moved along the respective slot 32 in the direction of the axis 14, the projections 30 are captively located as they cannot be moved in a transverse direction with respect to the slots 32, that is the transverse direction relative to the axis 14.

The transverse width of the projections 30 at the flanges 31 is wider than the transverse width of the neck 35.

The base 15 and member 16 have rows of serrations 36 that aid in ret the member 16 in a desired location relative to the base 15.

By sliding movement of the projections 30 along their respective slots 32, the position of the member 16 is adjustable relative to the base 15 in the direction of the axis 14. Once located in a desired position, the threaded fasteners passing through elongated slots 37 and threadably engaged within passages 38, are tensioned to retain the member 16 in a desired position in respect of the member 15, the position being maintained in assistance with engagement of the serrations 36. The slots 37 are elongated in the direction of the axis 14 to provide for relative adjustment, that is sliding movement of the projections 30 within their associated slots 32.

The member 16 has a longitudinal wall 39 and end walls 40 that engage the base flange 29 to aid in mounting the member 16 on the base 15.

A cover 41 covers the slots 37 and threaded fasteners passing therethrough.

The base 17 has a mounting plate 42 that is to be fixed to the door by means of threaded fasteners passing through apertures 43. Extending generally normal to the plate 42 is a base flange 44 having at least one transverse slot 45. The slots 45 extend generally transverse with respect to the axis 14. To cooperate with the slots 45 are projections 46 of the member 19, with the projections 46 being slidable along the slots 45 to provide for horizontal adjustment of the member 19 relative to the base 18. To aid in retaining the member 19 in a desired position relative to the base 18, the base 18 and member 19 are provided with a plurality of serrations 36.

The member 19 has a plurality of elongated slots 47 through which threaded fasteners pass to engage threaded passages 48. When the member 19 is in a desired position relative to the base 18, the threaded fasteners are tensioned to secure the member 19 in position fixed to the base 18 with the aid of engagement of the serrations 36.

A cover 49 is secured to the member 19 to cover the slots 47 and threaded fasteners passing therethrough.

The member 19 has a longitudinal side wall 50 and end walls 51 that engage the base flange 44 to aid in locating the member 19 with respect to the base 18.

In operation of the above described hinge 10, vertical adjustment of the hinge halves 11 and 12 relative to each other is accomplished by sliding movement of the projections 31 along their slots 32, while horizontal adjustment between the hinge halves 11 and 12 is achieved by sliding movement of the projections 46 along their respective slots 45 again until the threaded fasteners are tensioned. Accordingly the slots 45 provide for horizontal adjustment and the slots 32 vertical adjustment.

In installation of the above described hinge 10, the member 16 is moved towards the member 15 in a direction transverse of the axis 16 so that the projections 30 pass through their associated enlarged portions 33. Thereafter the member 16 is allowed to move downwardly parallel to the axis 14 until the flanges 31 are located behind the flanges 34. Accordingly the door is then partially retained in position, that is a position enabling adjustment.

1. A hinge including:
a first hinge half;
a second hinge half;
a pin pivotally coupling the hinge halves for pivoting movement about a pivot axis; and wherein
said first hinge half includes,
a base to be fixed to a door or door jamb,
a pin engaging member attached to the base and engaging the pin to pivotally attach the hinge halves, said pin engaging member being adjustable in a direction for movement generally parallel to said axis relative to said base, with the base and member being coupled by a slot extending generally parallel to said axis and a projection slidably located in said slot for sliding movement therealong and located in said slot so as to prevent separation of the projection and the slot in a transverse direction transverse relative to said axis.

2. The hinge of claim 1, said slot is a first slot and said projection is a first projection, with said base and member being coupled by a second slot, said second slot extending generally parallel to said axis, and a second projection, the second projection being slidably located in said second slot for movement therealong, said second projection being operatively associated with the second slot to prevent separation of the second slot and second projection in a transverse direction with respect to said axis.

3. The hinge of claim 1, wherein each projection includes at least one flange that prevents said transverse separation.

4. The hinge of claim 1, said each projection is attached to said base, and said member includes the slot/s.

5. The hinge of claim 1, each slot includes a neck defined between a pair of neck flanges, and each projection projects through a respective one of the necks, with each neck flange engaging the associated projection to prevent said transverse separation.

6. The hinge of claim 1, wherein said member includes at least one elongated slot through which a threaded fastener passes to secure the member to the base in a desired location with respect thereto.

7. The hinge of claim 1, wherein said base and member have serrations that engage to aid in retaining the member fixed to said base in a desired location.

8. The binge of claim 1, wherein said hinge second half includes a second half base and a second half pin engaging member adjustably attached to the second half base, with said pin pivotally coupling the member of said first hinge half and the member of said hinge second half.

9. The hinge of claim 8, wherein said hinge second half base has at least one slot extending generally transverse of said axis, and said hinge second half member has a projection located in said slot to provide for adjustment of said second hinge half to member with respect to said second hinge half base in a direction transverse of said axis.

10. The hinge of claim 1, wherein said second hinge half member has at least one slot extending generally transverse of said axis to receive a fastener and provide for relative adjustment of said second hinge half member relative to said second hinge half base.

11. The hinge of claim 2, wherein each projection includes at least one flange that prevents said transverse separation.

12. The hinge of claim 1, said each projection is attached to said base, and said member includes the slot/s.

13. The hinge of claim 12, each slot includes a neck defined between a pair of neck flanges, and each projection projects through a respective one of the necks, with each neck flange engaging the associated projection to prevent said transverse separation.

14. The hinge of claim 13, wherein said member includes at least one elongated slot through which a threaded fastener passes to secure the member to the base in a desired location with respect thereto.

15. The hinge of claim 14, wherein said base and member have serrations that engage to aid in retaining the member fixed to said base in a desired location.

16. The hinge of claim 15, wherein said hinge second half includes a second half base and a second half pin engaging member adjustably attached to the second half base, with said pin pivotally coupling the member of said first hinge half and the member of said hinge second half.

17. The hinge of claim 16, wherein said hinge second half base has at least one slot extending generally transverse of said axis, and said hinge second half member has a projection located in said slot to provide for adjustment of said second hinge half member with respect to said second hinge half base in a direction transverse of said axis.

18. The hinge of claim 17, wherein said second hinge half member has at least one slot extending generally transverse of said axis to receive a fastener and provide for relative adjustment of said second hinge half member relative to said second hinge half base.
